(19) United States
(12) Patent Application Publication
(10) Pub. No.: US 2012/0237369 A1
(43) Pub. Date: Sep. 20, 2012

(54) CYLINDER BLOCK OF PISTON-TYPE COMPRESSOR AND METHOD FOR MANUFACTURING THE SAME

(75) Inventors: Toshiyuki KOBAYASHI, Aichi-ken (JP); Mitsuyo ISHIKAWA, Aichi-ken (JP); Jun KONDO, Aichi-ken (JP)

(73) Assignee: KABUSHIKI KAISHA TOYOTA JIDOSHOKKI, Kariya-shi (JP)

(21) Appl. No.: 13/417,670

(22) Filed: Mar. 12, 2012

(30) Foreign Application Priority Data
Mar. 15, 2011 (JP) 2011-056424

(51) Int. Cl. F04B 27/10; B23P 15/00

(52) U.S. Cl. 417/269; 29/888.06

(57) ABSTRACT

A cylinder block of a piston-type compressor includes a main cylinder block, a shaft hole formed through the main cylinder block, a plurality of cylinder bores formed in the main cylinder block around the shaft hole, a separation wall formed integrally with the main cylinder block and closing one end of the cylinder bore, a first hole formed through the separation wall and a second hole formed linearly and connecting the cylinder bore and the shaft hole. The first hole is formed so that the first hole is located on an extended line of axis Q of the second hole and the diameter of the first hole is equal to or more than that of the second hole.

### BACKGROUND OF THE INVENTION

The present invention relates to a cylinder block of a piston-type compressor and a manufacturing method for the same.

Japanese Patent Application Publication 2006-83835 discloses a piston-type compressor including a cylinder block, a rotary shaft and a rotary valve that is formed integrally with the rotary shaft. In the suction stroke of the compressor, the rotary valve introduces refrigerant gas to be compressed into a cylinder bore formed in the cylinder block. The cylinder block has formed therethrough a shaft hole through which the rotary shaft passes and also formed therein a suction passage connecting the shaft hole and the cylinder bore. Additionally, the cylinder block has formed integrally therewith a separation wall and a discharge port is formed through the separation wall. In view of suction efficiency, the suction passage is formed to open to the cylinder bore at a position adjacent to the separation wall. This type of cylinder block can prevent refrigerant gas from leaking more effectively than a type of cylinder block in which the opposite ends of its cylinder bore are open without using a separation wall.

In the cylinder block of the piston-type compressor disclosed in the above Publication wherein the suction passage needs to be opened at a position adjacent to the separation wall, however, the presence of the separation wall makes it difficult to form the suction passage and hence to manufacture the cylinder block on an industrial basis.

The present invention, which has been made in light of the above problems, is directed to providing a cylinder block of a piston-type compressor that can be manufactured easily on an industrial basis and a method for manufacturing the same.

### SUMMARY OF THE INVENTION

A cylinder block of a piston-type compressor includes a main cylinder block, a shaft hole formed through the main cylinder block, a plurality of cylinder bores formed in the main cylinder block around the shaft hole, a separation wall formed integrally with the main cylinder block and closing one end of the cylinder bore, a first hole formed through the separation wall and a second hole formed linearly and connecting the cylinder bore and the shaft hole. The first hole is formed so that the first hole is located on an extended line of axis Q of the second hole and the diameter of the first hole is equal to or more than that of the second hole.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal sectional view of a piston-type compressor having a cylinder block according to a first embodiment of the present invention;

FIG. 2 is a partially enlarged sectional view showing the cylinder block of FIG. 1;

FIGS. 3A through 3C are schematic fragmentary views describing a method for processing the cylinder block of FIG. 1;

FIG. 4 is a rear view of the cylinder block of FIG. 1;

FIG. 5 is a fragmentary sectional view showing a cylinder block according to a second embodiment;

FIG. 6 is a rear view of the cylinder block of FIG. 5;

FIG. 7 is a fragmentary sectional view showing a cylinder block according to a first alternative embodiment of FIG. 1;

FIG. 8 is a fragmentary sectional view showing a cylinder block according to a second alternative embodiment of FIG. 1;

FIG. 9 is a fragmentary sectional view showing a cylinder block according to a third alternative embodiment of FIG. 1; and

FIG. 10 is a partially enlarged sectional view showing the cylinder block according to another alternative embodiment.

### DETAILED DESCRIPTION OF THE PREFERRED EMBODIMENTS

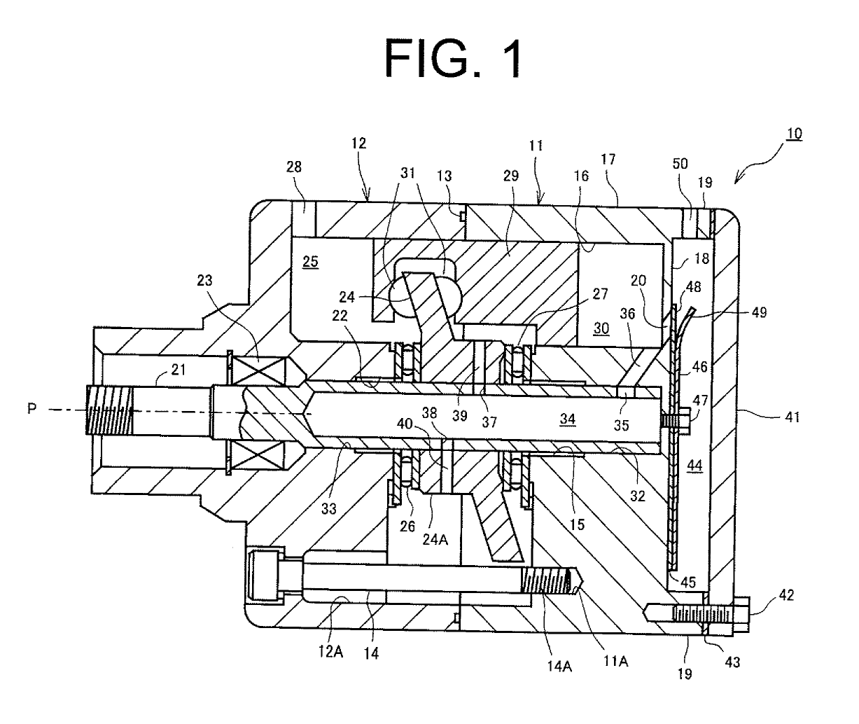

The following will describe a cylinder block of a piston-type compressor according to a first embodiment and a method for manufacturing the same with reference to the accompanying drawings. A piston-type compressor (hereinafter referred to as a compressor) shown in FIG. 1 that is designated by numeral 10 is a fixed displacement swash plate type compressor. The left and the right as seen in FIG. 1 correspond to the front and the rear of the compressor 10, respectively.

As shown in FIG. 1, the compressor 10 includes a cylinder block 11, a front housing 12 joined to the front end of the cylinder block 11 and an annular seal member 13 interposed between the cylinder block 11 and the front housing 12. A bolt 14 having an external thread 14A at an end thereof is passed through a hole 12A formed through the front housing 12 and screwed into an internal thread 11A formed in the cylinder block 11. A plurality of such bolts 14 and their corresponding holes 12A and the internal threads 11A are provided in the compressor 10, as indicated in FIG. 1.

The cylinder block 11 includes a main cylinder block 17, a separation wall 18 formed integrally with the main cylinder block 17 and a rear outer wall 19 formed also integrally with the main cylinder block 17. The main cylinder block 17 has formed therethrough a shaft hole 15 in the center thereof and a plurality of cylinder bores 16 disposed around the shaft hole 15 at equiangular spaced intervals and extending parallel to the axis P of the shaft hole 15. The main cylinder block 17 is opened on the front side thereof and closed on the rear side thereof by the separation wall 18. The separation wall 18 has formed therethrough a discharge port 20 as the first hole of the present invention. The outer wall 19 is formed annularly at the outer peripheral end surface of the separation wall 18 so as to extend rearward.

A rotary shaft 21 is rotatably supported by the cylinder block 11 and the front housing 12. The rotary shaft 21 is passed through a shaft hole 22 formed through the front housing 12 and the shaft hole 15 of the cylinder block 11. The rotary shaft 21 is supported directly by the front housing 12 and the cylinder block 11 through the shaft holes 22, 15, respectively. A seal member 23 is interposed between the front housing 12 and the rotary shaft 21. A swash plate 24 is fixed on the rotary shaft 21 for rotation therewith and housed in a crank chamber 25 formed between the front housing 12 and the cylinder block 11.

Thrust bearings 26, 27 are interposed between the end surface of the front housing 12 on the swash plate 24 side and annular base 24A of the swash plate 24 and between the end surface of the cylinder block 11 on the swash plate 24 side and the annular base 24A of the swash plate 24, respectively. The front housing 12 has formed therethrough an inlet 28 connecting external refrigerant circuit (not shown) and the crank chamber 25.

The cylinder bore 16 of the cylinder block 11 receives therein a piston 29 that defines a compression chamber 30 in the interior of the cylinder bore 16 and is moved reciprocally in accordance with the rotation of the rotary shaft 21. A shoe 31 is provided between the swash plate 24 and the piston 29 for transmitting the rotating motion of the swash plate 24 to the reciprocal movement of the piston 29.

A part of each of the inner surfaces of the shaft hole 15 of the cylinder block 11 and of the shaft hole 22 of the front housing 12 through which the rotary shaft 21 passes is formed as cylindrical seal surfaces 32, 33, respectively. The cylindrical seal surfaces 32, 33 are formed with a diameter that is smaller than that of the shaft holes 15, 22 in the region other than the seal surfaces 32, 33. Thus, the rotary shaft 21 is supported directly by the seal surfaces 32, 33 of the cylinder block 11 and the front housing 12, respectively.

The rotary shaft 21 has formed therein axially a supply passage 34 extending frontward to the dead end from the rear end of the rotary shaft 21 blocked by the cylinder block 11. An introduction passage 35 is formed in the rotary shaft 21 so as to communicate with the supply passage 34.

The cylinder block 11 has formed therein a suction passage 36 as the second hole of the present invention, extending between the cylinder bore 16 and the shaft hole 15. The suction passage 36 has one end thereof located on the seal surface 32 of the shaft hole 15 and the other end of the suction passage 36 opened at a position adjacent to the separation wall 18. The introduction passage 35 communicates with the suction passage 36 intermittently in accordance with the rotation of the rotary shaft 21.

A part of the rotary shaft 21 that is surrounded by the seal surface 32 forms a rotary valve. As shown in FIG. 1, communication holes 37, 38 are formed in the rotary shaft 21. The base 24A of the swash plate 24 has formed therethrough communication passages 39, 40 that are communicable with the communication holes 37, 38, respectively. The communication holes 37, 38 and the communication passages 39, 40 connect between the supply passage 34 of the rotary shaft 21 and the crank chamber 25.

A rear housing 41 in the form of a flat plate is joined to the rear end surface of the outer wall 19 of the cylinder block 11 through a seal member 43 such as a gasket by a plurality of bolts 42 (only one bolt being shown in FIG. 1). The rear housing 41, the separation wall 18 and the outer wall 19 cooperate to form a discharge chamber 44. The outer wall 19 has formed therethrough an outlet 50 that connects the discharge chamber 44 and the external refrigerant circuit. A valve forming plate 45 and a retainer forming plate 46 are fixed together to the separation wall 18 by a bolt 47. The valve forming plate 45 has formed therein a reed valve type discharge valve 48. The retainer forming plate 46 forms a retainer 49 that regulates the opening of the discharge valve 48.

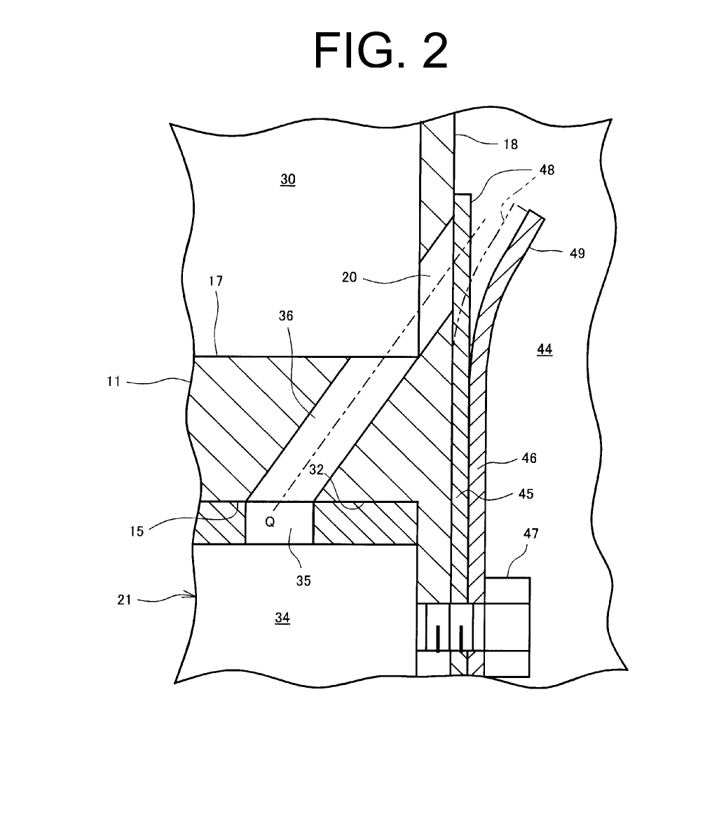

The first embodiment is characterized by the discharge port 20 and the suction passage 36 that are formed in the cylinder block 11. The following will describe such feature. As shown in FIG. 2, the suction passage 36 is formed linearly through the main cylinder block 17 at an inclined angle with respect to the radial direction of the shaft hole 15. As shown in FIG. 2, the discharge port 20 is formed through the separation wall 18, extending along the axis Q of the suction passage 36. In other words, the discharge port 20 is located in the separation wall 18 in facing relation to the piston 29 and also adjacent to the shaft hole 15. Additionally, the discharge port 20 is formed so as to have the same diameter as the suction passage 36 and to be coaxial with the suction passage 36.

The following will describe a manufacturing method of the cylinder block 11. The cylinder block 11 is made by die-casting aluminum-based metal. The cylinder block 11 as cast is formed with the separation wall 18 and the outer wall 19 after casting and the suction passage 36 and the discharge port 20 are yet to be formed. The cylinder block 11 in process undergoes machining of various parts thereof. The end of the cylinder block 11 is formed by machining and the shaft hole 15, the suction passage 36 and the discharge port 20 are formed by drilling.

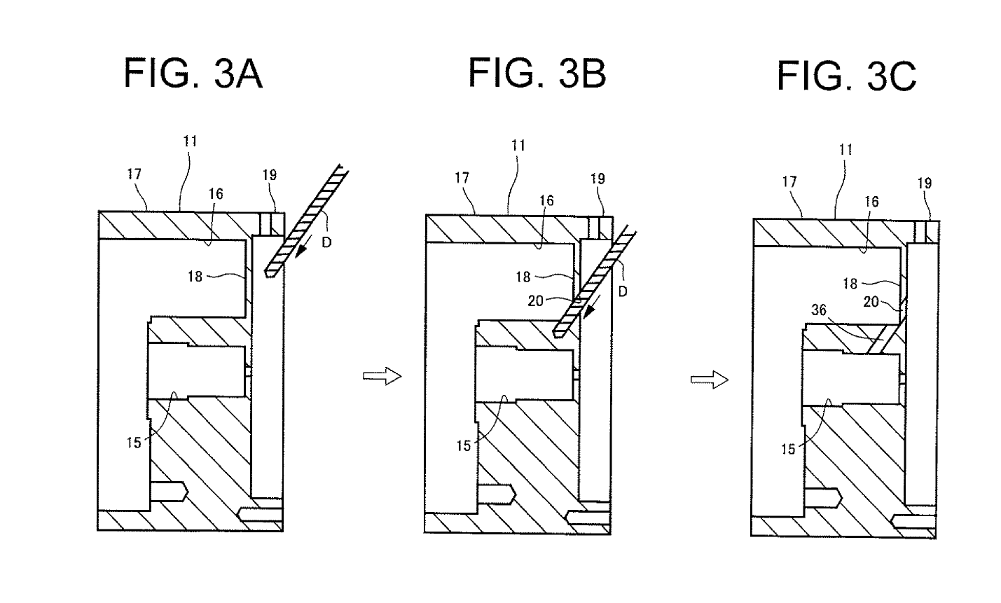

FIG. 3A is a sectional view of the cylinder block 11 having formed therethrough the shaft hole 15, showing a state before the suction passage 36 and the discharge port 20 are formed by drilling. As shown in FIG. 3A, a drill D as a drilling tool is set so as to face the separation wall 18 at an angle. The separation wall 18 is drilled through by the drill D, so that the discharge port 20 is formed through the separation wall 18, as shown in FIG. 3B. Subsequently, the drill D is moved forward further into the shaft hole 15, so that the suction passage 36 is formed through the main cylinder block 17, as shown in FIG. 3C. Finally, the drill D is removed, with the result that the discharge port 20 and the suction passage 36 are formed completely. In the first embodiment, the discharge port 20 and the suction passage 36 are formed continuously by one stroke movement of the drill D.

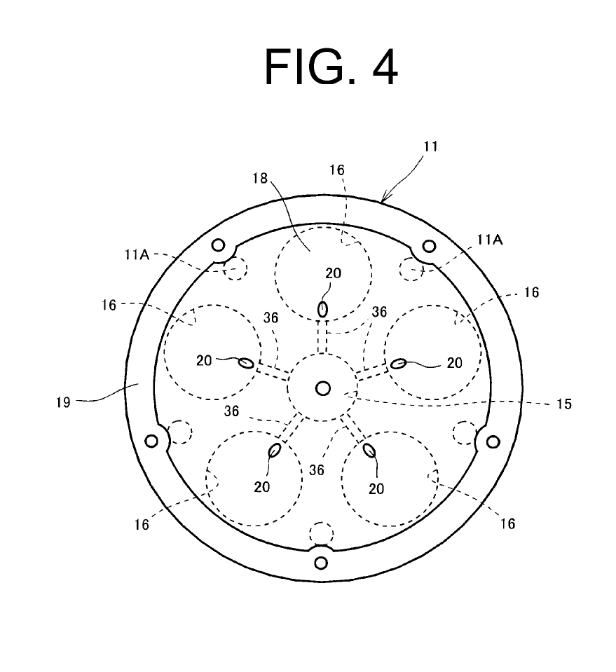

FIG. 4 is a rear view of the cylinder block 11 as seen from the side of the outer wall 19, showing a state after the drilling has been completed. As shown in FIG. 4, the discharge ports 20 each having an elliptic shape are formed at positions corresponding to the respective cylinder bores 16. Additionally, the suction passages 36 are formed so as to connect the respective cylinder bores 16 and the shaft hole 15.

The following will describe the operation of the compressor 10 having the cylinder block 11. When the rotary shaft 21 is rotated by the rotating force of a power source, the rotational movement of the swash plate 24 rotating integrally with the rotary shaft 21 is transmitted to the piston 29 through the shoe 31 so that the piston 29 reciprocates in the cylinder bore 16. Refrigerant gas at suction pressure in the external refrigerant circuit is introduced into the crank chamber 25 through the inlet 28. Subsequently, refrigerant gas in the crank chamber 25 is transferred into the supply passage 34 through the communication passages 39, 40 in the swash plate 24 and the communication holes 37, 38 in the rotary shaft 21.

When the cylinder bore 16 is in the suction stroke (or when the piston 19 moves leftward in FIG. 1), the introduction passage 35 is in communication with the suction passage 36, so that refrigerant gas in the supply passage 34 of the rotary shaft 21 is introduced into the compression chamber 30 through the introduction passage 35 and the suction passage 36.

When the cylinder bore 16 is in the discharge stroke (or when the piston 19 moves rightward in FIG. 1), the communication between the introduction passage 35 and the suction passage 36 is completely blocked, so that refrigerant gas in the compression chamber 30 is discharged into the discharge chamber 44 through the discharge port 20 while pushing the discharge valve 48 open. Subsequently, refrigerant gas is discharged from the discharge chamber 44 into the external refrigerant circuit (not shown) through the outlet 50. Refrigerant gas flowing through the external refrigerant circuit is returned to the crank chamber 25 through the inlet 28.

In the first embodiment, with the discharge valve 48 opened when refrigerant gas is discharged from the compression chamber 30 through the discharge port 20, the extension of the discharge valve 48 indicated by a chain double-dashed line in FIG. 2 and the axis Q of the suction passage 36 are substantially parallel to each other. The refrigerant gas flowing through the discharge port 20 flows out smoothly without receiving the resistance from the discharge valve 48, with the result that no excessive compression of refrigerant gas occurs.

The manufacturing method according to the first embodiment of the present invention offers the following advantageous effects.
(1) The discharge port 20 and the suction passage 36 can be formed continuously by the drill D. Thus, the manufacturing method for the cylinder block 11 of the compressor 10 is suitable for manufacturing on an industrial basis.
(2) The discharge port 20 and the suction passage 36 are formed with the same diameter, so that the discharge port 20 and the suction passage 36 can be drilled without changing the drill D. Additionally, the discharge port 20 and the suction passage 36 can be formed only by one stroke movement of the drill D.
(3) The discharge port 20 is formed at an inclined angle with respect to the thickness direction of the separation wall 18. Accordingly, the flowing direction of compressed refrigerant gas flowing out through the discharge port 20 is inclined with respect to the thickness direction of the separation wall 18. According to the first embodiment of the present invention, the discharge valve 48 can be opened while being bent along the inclined direction of the discharge port 20 depending on the position of the discharge valve 48. Such opening of the discharge valve 48 allows refrigerant gas to be discharged from the cylinder bore 16 smoothly because of the reduced flowing resistance.
(4) The discharge port 20 and the suction passage 36 may be formed continuously in this order by drilling from the separation wall 18 side, so that the suction passage 36 can be formed easily.

The following will describe the cylinder block of a piston-type compressor according to the second embodiment and a method for manufacturing the same with reference to the accompanying drawings. The cylinder block of the second embodiment differs from that of the first embodiment in that the cylinder block has an oil passage as the third hole of the present invention in addition to the discharge port and the suction passage as the first hole and the second hole, respectively, in the cylinder block of the first embodiment. The rest of the structure of the second embodiment is substantially the same as that of the first embodiment. In the following description of the second embodiment, the same reference numerals denote the same or similar elements or components of the first embodiment, and the description thereof will be omitted or simplified.

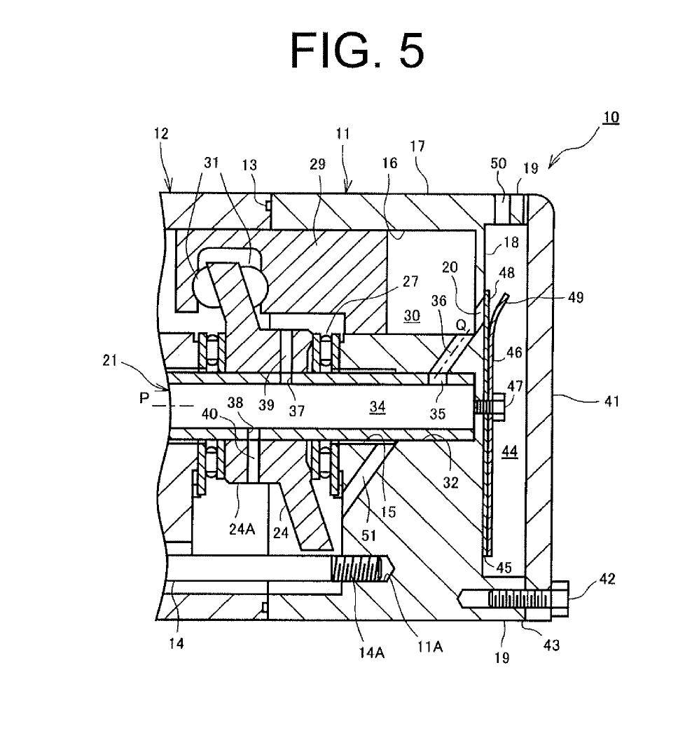

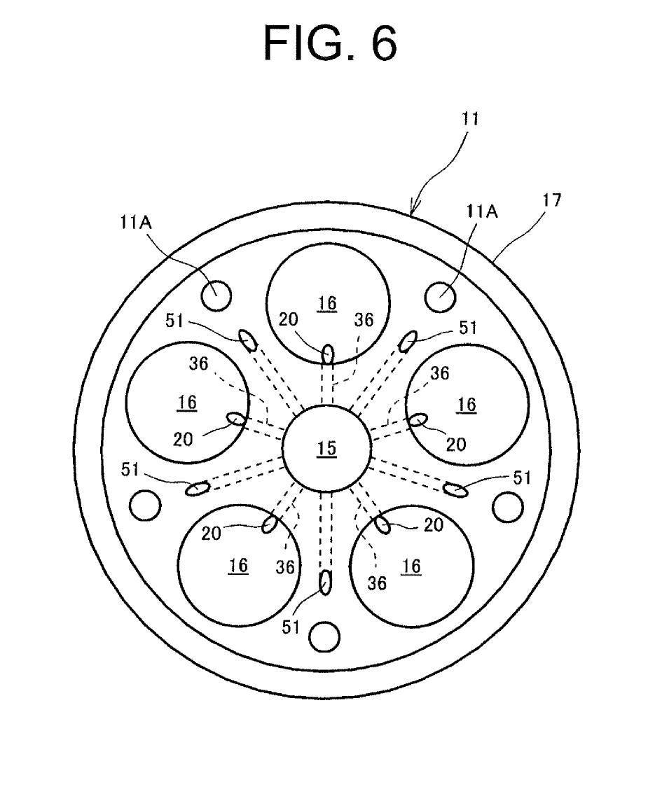

As shown in FIG. 5, an oil passage 51 as the third hole of the cylinder block 11 is formed coaxially with the axis Q of the discharge port 20 and the suction passage 36 so as to face the suction passage 36 across the shaft hole 15. The oil passage 51 is formed in the main cylinder block 17 so as to extend from the shaft hole 15 to the front side of the main cylinder block 17 that is on the side of the opening end of the cylinder bore 16. As shown in FIG. 6, the oil passage 51 is opened at a position between any two adjacent cylinder bores 16 without interfering with the cylinder bore 16. In the compressor 10, the oil passage 51 connects the crank chamber 25 and the seal surface 32 of the cylinder block 11. Therefore, lubrication oil in the crank chamber 25 is introduced into the oil passage 51 to lubricate between the rotary shaft 21 and the seal surface 32 of the cylinder block 11.

In the cylinder block 11 of the second embodiment, the discharge port 20, the suction passage 36 and the oil passage 51 may be formed in this order by drilling from the separation wall 18 side. Alternatively, the oil passage 51, the suction passage 36 and the discharge port 20 may be formed in this order by drilling from the front side of the main cylinder block 17 that is on the side of the opening end of the cylinder bore 16. In the second embodiment, the discharge port 20, the suction passage 36 and the oil passage 51 can be thus formed by drilling either from the outside of the separation wall 18 side or from the front side of the main cylinder block 17, so that the freedom of manufacturing the cylinder block 11 is improved.

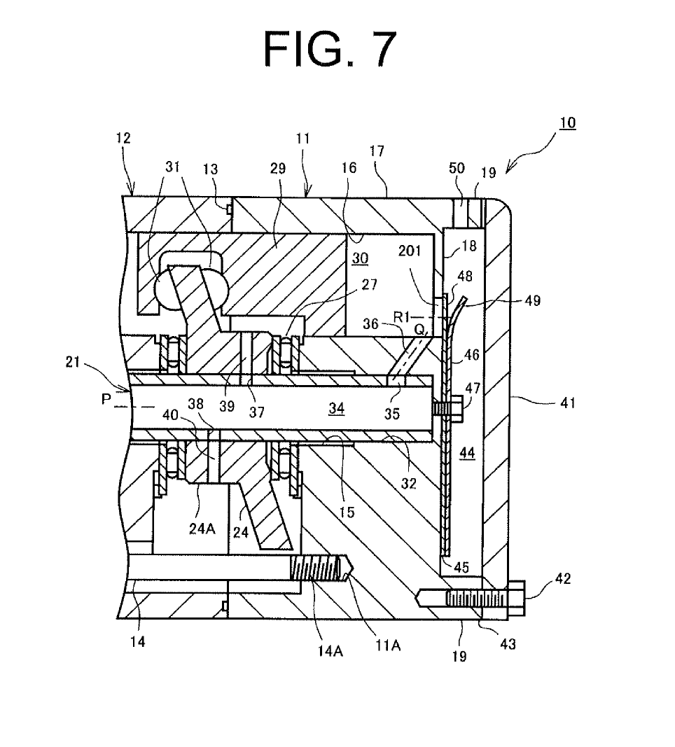

The following will describe the cylinder block 11 according to first through third alternative embodiments derived from the first and the second embodiments. Referring to FIG. 7 showing the cylinder block 11 according to the first alternative embodiment, the discharge port 201 may be formed by further machining the discharge port 20 that is formed by the manufacturing method according to the first embodiment. The discharge port 201 of the first alternative embodiment is formed with a diameter that is larger than that of the suction passage 36. More particularly, the diameter of the discharge port 201 is larger than that of the suction passage 36, but smaller than that of the cylinder bore 16 so as to make the discharge port 201 to function as the discharge port. The axis R1 of the discharge port 201 extends in the thickness direction of the separation wall 18 that is parallel to the axis P of the shaft hole 15. Accordingly, the shape of the discharge port 201 at the opening thereof is not elliptic but circular. The area of the cross section of the suction passage 36 as projected on the surface of the separation wall 18 falls within the area of the discharge port 201. The area of the discharge port 201 is larger than that of the discharge port 20 of the first and the second embodiments, so that the delivery of compressed refrigerant gas can be increased in the compressor 10 according to the first alternative embodiment and, therefore, excessive compression of refrigerant gas is prevented. Additionally, the shape of the discharge valve 48 may be modified so as to conform to the circular shape of the discharge port 201, so that the discharge valve 48 can be formed easily.

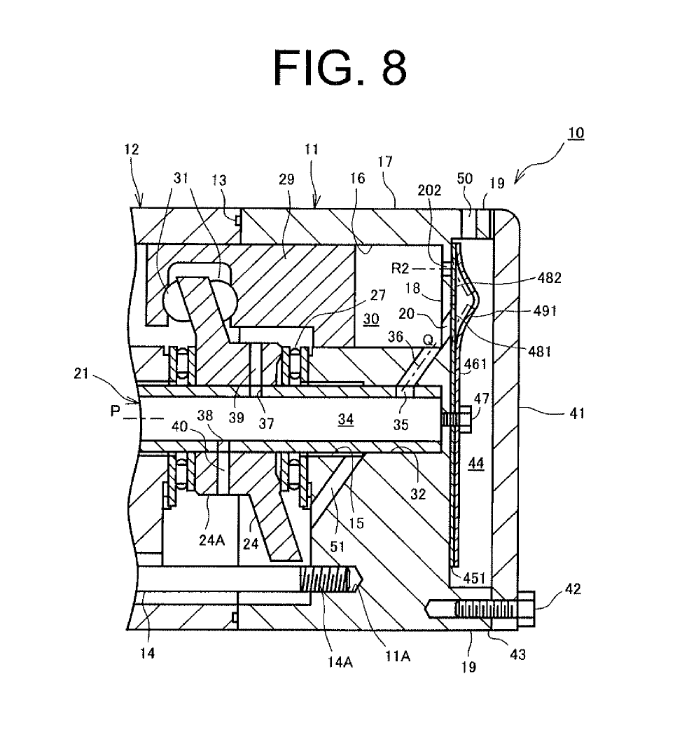

Referring to FIG. 8 showing the cylinder block 11 according to the second alternative embodiment, another discharge port 202 is formed through the separation wall 18 in addition to the discharge port 20 that is formed by the manufacturing method according to the first embodiment. The discharge port 202 is formed at a position other than the position of the discharge port 20. The axis R2 of the discharge port 202 extends in the thickness direction of the separation wall 18 that is parallel to the axis P of the shaft hole 15. Both of the discharge ports 20, 202 are used as the discharge port of the compressor 10. In this case, as shown in FIG. 8, the discharge valves 481, 482 corresponding to the discharge ports 20, 202, respectively, are formed by the discharge valve forming plate 451 and the retainer 491 is formed by the retainer forming plate 461. In the second alternative embodiment, the delivery of compressed refrigerant gas can be also increased and, therefore, excessive compression of refrigerant gas is prevented.

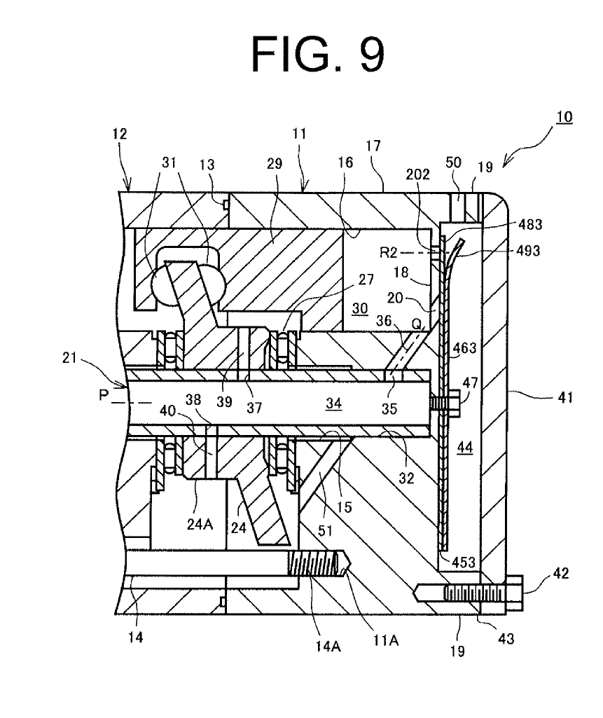

Referring to FIG. 9, the structure of the cylinder block 11 according to the third alternative embodiment is substantially the same as that of the second alternative embodiment shown in FIG. 8. In the third embodiment, the discharge port 20 that is formed by the manufacturing method according to the first embodiment is completely closed by the discharge valve forming plate 453 functioning also as a gasket and only the discharge port 202 is used as the discharge port of the compressor 10 of the third alternative embodiment. The retainer 493 is formed by the retainer forming plate 463 at a position corresponding to the discharge valve 483 formed by the discharge valve forming plate 453. In the third embodiment, only the discharge port 202 functions as the discharge port of the compressor 10 without being restricted by the location of the discharge port 20.

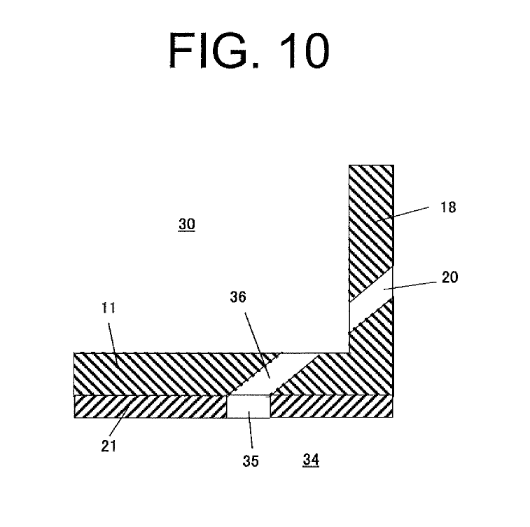

The present invention is not limited to the above embodiments but may be practiced in various ways as exemplified below.
The compressor having a cylinder block according to the present invention is not limited to a fixed displacement type shown in the above embodiments, but it may be of a variable displacement type having a rotary valve rotating integrally with a rotary shaft. Additionally, the compressor of fixed displacement type is not limited to a single-headed piston type, but it may be of a double-headed piston type.
In the above-described embodiments, the first and the second holes are used as the discharge port and the suction passage, respectively, but the first and the second holes may be used as the suction port for introducing refrigerant gas to be compressed into the compression chamber and the discharge passage for discharging compressed refrigerant gas, respectively.
In the above-described embodiments, the discharge port as the first hole is formed through the separation wall at a position adjacent to the shaft hole for the rotary shaft because of the restriction due to the position and the inclined angle of the suction passage. However, the discharge port as the first hole may be formed through the separation wall at a position far from the shaft hole for the rotary shaft by changing the position and the inclined angle of the suction passage.
In the above-described embodiments, the discharge port 20 as the first hole and the suction passage 36 as the second hole are both formed at positions adjacent to the outer periphery of the separation wall 18 as shown in FIG. 2. The discharge port 20 as the first hole and the suction passage 36 as the second hole may be both formed at position a little far from the outer periphery of the separation wall 18 as shown in FIG. 10. When the suction passage 36 as the second hole is formed at a position adjacent to the outer periphery of the separation wall 18 and the piston 29 moves leftward immediately after the piston 29 completes the suction stroke, the residual refrigerant gas in the suction passage 36 may flow back to the cylinder bore thereby to affect the compression efficiency. When the suction passage 36 as the second hole is formed at a position a little far from the outer periphery of the separation wall 18, the introduction passage 35 is formed so that the suction passage 36 is in communication with the supply passage 34 before the suction passage 36 is in communication with the cylinder bore with the result that the residual refrigerant gas in the suction passage 36 flows to the supply passage 34.
In the first through the third alternative embodiments, the cylinder block is formed by the manufacturing method according to the first embodiment, but it may be formed by the manufacturing method according to the second embodiment

What is claimed is:

1. A cylinder block of a piston-type compressor comprising:
a main cylinder block;
a shaft hole formed through the main cylinder block;
a plurality of cylinder bores formed in the main cylinder block around the shaft hole;
a separation wall formed integrally with the main cylinder block and closing one end of the cylinder bore;
a first hole formed through the separation wall; and
a second hole formed linearly and connecting the cylinder bore and the shaft hole, wherein the first hole is formed so that the first hole is located on an extended line of axis Q of the second hole and the diameter of the first hole is equal to or more than that of the second hole.

2. The cylinder block of the piston-type compressor according to claim 1, wherein the first hole is formed to be coaxial with the second hole and to have the same diameter as the second hole.

3. The cylinder block of the piston-type compressor according to claim 2, wherein the first hole is formed to be inclined with respect to the thickness direction of the separation wall.

4. The cylinder block of the piston-type compressor according to claim 1, further comprising:
a third hole formed to be coaxial with the second hole, wherein the third hole extends from the shaft hole to front side of the main cylinder block that is on opening end side of the cylinder bore in the main cylinder block.

5. A method for manufacturing a cylinder block of a piston-type compressor, wherein the cylinder block comprising:
a main cylinder block;
a shaft hole formed through the main cylinder block;
a plurality of cylinder bores formed in the main cylinder block around the shaft hole;
a separation wall formed integrally with the main cylinder block and closing one end of the cylinder bore;
a first hole formed through the separation wall; and
a second hole formed linearly and connecting the cylinder bore and the shaft hole, the method characterized by the step of:
forming the first hole and the second hole continuously by drilling.

6. The method for manufacturing the cylinder block of the piston-type compressor according to claim 5, wherein the first hole is formed before the second hole.

7. The method for manufacturing the cylinder block of the piston-type compressor according to claim 5, wherein the cylinder block further comprising:
a third hole formed to be coaxial with the second hole, wherein the third hole extends from the shaft hole to front side of the main cylinder block that is on opening end side of the cylinder bore in the main cylinder block, characterized by the step of:
forming the third hole continuously with the first hole and the second hole.
